(19) United States
(12) Patent Application Publication
(10) Pub. No.: US 2007/0145631 A1
(43) Pub. Date: Jun. 28, 2007

(54) Process for producing shaped parts having laminated structures

(76) Inventor: Oliver Salzmann, Willich (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/642,352

(22) Filed: Dec. 20, 2006

(30) Foreign Application Priority Data
Dec. 23, 2005 (DE) DE102005062352.2

(51) Int. Cl. B32B 15/04

(52) U.S. Cl. 264/171.14; 264/513; 264/553; 29/609

(57) ABSTRACT

The invention concerns a method for manufacturing a molded laminate (1) of multilayer design (2) and three-dimensional shape that is particularly suitable for the manufacture of furniture, decorative elements, hollow channels, automobile accessories or the like, wherein an at least substantially plate-shaped material piece (6) of multilayer design (2) is reshaped into a molded laminate (1), particularly by means of thermoforming, and wherein the material piece (6) comprises at least one formable support (3), particularly a thermoformable support, and at least one planar material (4) associated the support (3). The planar material (4) is laminated onto the support (3) during the reshaping of the material piece (6) in such a way that the support (3) and the planar material (4) can be displaced on and/or relative to one another during the reshaping process and a molded laminate (1), in which the planar material (4) and the support (3) are immovably connected to one another, is obtained after the completion of the reshaping process.

### CROSS REFERENCES TO RELATED APPLICATIONS

This application claims priority to German Patent Application No. DE 10 2005 062 352.2, filed Dec. 23, 2005, “PROCESS FOR PRODUCING SHAPED PARTS HAVING LAMINATED STRUCTURE”. This reference is expressly incorporated by reference herein, in its entirety.

### BACKGROUND OF THE INVENTION

The present invention pertains to a method for manufacturing a molded laminate according to the disclosure and to a molded laminate manufactured by means of the invented method.

With respect to the manufacture of multilayer molded laminates that contain a thermoplastic component or layer and are synonymously relative to as moldings in the context of the present invention, the state of the art consists of initially reshaping a formable material, generally formed as sheets, into the desired three-dimensional shape by means of suitable methods. Another layer such as, for example, a planar textile material or the like can be applied and permanently fixed on the resultant three-dimensional molded laminate in a subsequent step. The planar material is fixed on the molded laminate, for example, by means of bonding or the like.

In this case, it is disadvantageous that the planar material is applied after the reshaping process, namely because this complicates the bonding process and the large number of production steps is quite labor-intensive and therefore costly. One particular problem is that it is frequently impossible to connect the planar material to the reshaped material over its entire surface; the planar material is subjected to substantial tensile and compressive stresses, in particular, in regions in which significant reshaping has occurred (e.g., in tightly curved areas, on indentations or bulges and the like), with these stresses frequently leading to the separation or delamination of the planar material. In addition, undesirable creases are frequently formed when the planar material is subsequently applied on the already reshaped material.

Another disadvantage of this method is that the subsequent fixing of a planar textile material on the three-dimensional structure can result in the planar textile material being subjected to uneven tensile stresses that, in turn, lead to an irregular surface appearance. The high and nonuniform restoring forces resulting from the subsequent and sometimes uneven application of the planar textile material to the support structure lead to the subsequent deformation of the molded laminate.

DE 36 12 834 A1 submitted by the same applicant describes a bonded fabric consisting of a layer of a foamed material, on which a textile fabric is laminated. According to this publication, the textile fabric is applied to the layer of foamed material before the ultimate shaping takes place. However, it is disadvantageous that the foamed material must first be provided with a skin or closed at the surface pores in order to even be subjected to a shaping process. This sometimes results in a composite material with a reduced load-bearing capacity and a low dimensional stability due to the elasticity of the foamed material. The lack of an additional supporting material also makes this composite unsuitable for the high stresses that occur in self-supporting structures capable of bearing a load, particularly seats. The described method is furthermore time-consuming and costly with respect to the equipment expenditures due to the absolutely imperative covering of the foamed material with a skin.

Based on of these technical circumstances, the present invention aims to provide a method for manufacturing a multilayer molding or molded laminate, in which the above-described disadvantages of the state of the art are at least partially eliminated or at least diminished. The invention specifically aims to disclose a method in which the respective layers of the molded laminate in the form of a composite system are subjected to low tensile and compressive stresses during the manufacture and the reshaping process, respectively. It should be possible to realize tight curvatures, indentations and bulges or the like in the molded laminate without causing individual layers of the molded laminate to delaminate or form creases. The resulting molded laminate should also be self-supporting and have a high dimensional stability such that it is particularly suitable for use in the furniture industry, especially for seats.

According to the present invention, the aforementioned objective is attained with a method for manufacturing a multilayer molded laminate of three-dimensional shape according to the disclosure. Other advantageous embodiments form the objects described herein.

The objective of the present invention is also attained with a molded laminate according to the present disclosure that is manufactured by means of the invented method and particularly suitable for the manufacture of furniture, decorative elements, hollow channels and the like.

Consequently, a first aspect of the present invention pertains to a method for manufacturing a multilayer molded laminate of three-dimensional shape, particularly for the manufacture of furniture, decorative elements and hollow channels, automobile fixtures (e.g., door linings) and the like. In the context of the invented method, an essentially plate-shaped material piece of multilayer design is initially reshaped into a molded laminate, particularly by means of thermoforming. The material piece used for this purpose contains at least one formable or, in particular, thermoformable support and at least one planar material or, in particular, one planar textile material associated with the support. One peculiarity of the invented method is that the planar material is laminated on the support during the reshaping of the material piece, namely such that the support and the planar material can be displaced on and/or relative to one another during the reshaping process. Another peculiarity of the invented method is that a molded laminate in which the planar material and the support are immovably connected to one another is obtained after the reshaping process.

Consequently, one central objective of the present invention consists of making available a method in which the respective layers can be displaced on or relative to one another during the reshaping of the material piece into a three-dimensional molded laminate such that the respective layers are essentially able to glide on one another during the reshaping process. This results in an “afterflow” or “continued sliding” of the respective layers, particularly of the planar material, during the reshaping process, so that significantly lower tensile and compressive stresses result, particularly with respect to the planar material. This makes it possible to effectively counteract the formation of creases and bubbles, delamination and the formation of cracks or tears.

A three-dimensional molded laminate according to the invention, in particular, with at least one planar material, particularly a planar textile material, associated at least one support is manufactured with the invented method. In this case, the molded laminate according to the invention can feature tight curvatures or deformed regions such that individual shapes and structures are realized that are adapted to the respective requirements—for example, an anatomically shaped molded laminate with a high load bearing capacity for seats.

Due to the utilization of the preferably planar textile material that is laminated on a support consisting, for example, of a non-porous thermoplastic material or thermoplastic foamed material, it is possible to form surfaces with exceptional haptic and optical properties so that the molded laminate is particularly suitable for the manufacture of furnishings. According to the invention, it is also possible to laminate another support, preferably of a foamed material, on a non-porous thermoplastic support, with the preferably planar textile material then being laminated onto the additional support. It is furthermore possible—as described further below—to equip the side facing away from the planar material with another material layer, particularly a planar textile material or another support, particularly a foam-like support. This results in a “sandwich structure” in which the non-porous thermoplastic support forms, in essence, the core layer of the laminate or composite material.

According to the invention, the term “plate-shaped” (e.g., plate-shaped material piece) refers to an at least essentially plane or planar shape, particularly of the material piece used for the manufacture of the molded laminate, where the thickness of the material piece is at least essentially constant over its surface. If so required for certain applications, the thickness of the individual layers can, however, also vary over their surface, for example, in order to realize an additionally optimized shape of seats.

In the context of the present invention, the term “formable” (e.g., formable support or formable material piece) should be understood in the sense that the support or the material piece can be transformed into another shape or form in an at least essentially irreversible fashion while preserving the mass of the layered structure.

In this context, the term “thermoformable” (e.g., thermoformable support or thermoformable material piece) should be understood in the sense that the support or the material piece can be reshaped, particularly by means of hot-forming, by heating the respective component, for example, to a temperature range above the softening temperature of the thermoplastic support. A person skilled in the art is sufficiently familiar with suitable methods of the pertinent type. For example, the thermoforming can be carried out in the form of deep-drawing, vacuum forming, vacuum deep-drawing and the like. In the reshaping method, conventional dies known to a person skilled in the art can be used respectively pressing or drawing the starting product to be reshaped, in this case the plate-shaped material piece, into a mold in order to obtain a three-dimensional molded laminate. A person skilled in the art is sufficiently familiar with dies and molds used for this purpose.

The term “on and/or relative to one another” (for example, with respect to the ability to displace the support and the planar material) should be understood in the context of the present invention to mean that the respective layers of the molded laminate, particularly the support on one hand and the planar material on the other hand, can be displaced during the reshaping process relative to their surface, i.e., along their boundary or contact surfaces. In other words, the mating or contacting of the respective layer surfaces is at least essentially preserved and not interrupted. On the contrary, an “afterflow” or “continued sliding” of the corresponding layers takes place during the reshaping process in the method according to the invention, wherein the respective layers continue to at least essentially remain in contact with one another.

Furthermore, the term “three-dimensional” (e.g., three-dimensional shape or structure of the molded laminate) refers to a shape or structure that features shaped or spatial areas that deviate from a plane or planar structure and include, but are not limited to, depressions and bulges, indentations, curvatures and the like.

In addition, the term “dimensionally stable” (e.g., dimensionally stable material piece or molded laminate) should be understood in the context of the invention to mean that the invented laminate is able to withstand and absorb the loads occurring in the respective application, for example, during the course of the manufacture of seats.

The term “associated” (e.g., planar material associated with the support) should be understood in the context of the invention to mean that it is possible to laminate or fix the planar material directly on the support, this term likewise including a direct association of the planar material relative to the support. In this case, additional supports in the sense of an intermediate layer are arranged between the planar material and the support.

Finally, the terms “laminating on” or “laminating” (e.g., laminating the planar material on the support) refer, in particular, to the production of a two-dimensional connection or bond between the respective layers of the material piece, wherein the connection between the individual layers can be produced, for example, with conventional methods known to a person skilled in the art, particularly laminating methods that are generally carried out by means of suitable laminating means such as adhesives, hot-melt adhesives, hot-melt webs and the like. In this context, the two-dimensional connection or lamination between the individual layers is preferably produced over the entire surface, i.e., the laminating means are preferably applied continuously. However, it would also be conceivable to produce a discontinuous connection, for example, by applying the adhesive in a punctiform or grid-like fashion. According to one special embodiment, the respective layers of the material piece or molded laminate can be connected to one another with flame bonding methods known to a person skilled in the art, while it should be ensured, in particular, that at least one layer has adhesive properties under the influence of heat.

Other advantages, characteristics, properties and aspects of the present invention result from the following description of preferred embodiments that refers to the figures.

### BRIEF SUMMARY

A method for manufacturing a molded laminate of multilayer design and three-dimensional shape, in which a plate-shaped material piece of multilayer design is reshaped into a molded laminate, wherein the material piece comprises at least one formable support and at least one planar material associated with the support, wherein the method comprises a step in which the planar material is laminated onto the support during the reshaping of the material piece, in such a way that the support and the planar material are displaced on and/or relative to one another during the reshaping process and a molded laminate, in which the textile material and the support are immovably connected to one another, is obtained after the completion of the reshaping process.

One object of the present disclosure is to describe an improved method for manufacturing a molded laminate of multilayer design and three-dimensional shape.

### BRIEF DESCRIPTION OF THE SEVERAL VIEWS OF THE DRAWINGS

FIG. 1A is a schematic representation of a molded laminate manufactured with the invented method, wherein the molded laminate has a 2-layer structure.

FIG. 1B is a schematic representation of an alternative embodiment of a molded laminate manufactured by means of the invented method, wherein the molded laminate has a 5-layer structure.

FIG. 2 is a schematic representation of a process sequence according to the invention, in which a material piece is reshaped into a molded laminate according to the invention.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

In the different figures, identical or similar components are identified by the same reference symbol, wherein corresponding properties and advantages are realized even if a repeated description is omitted for reasons of simplicity.

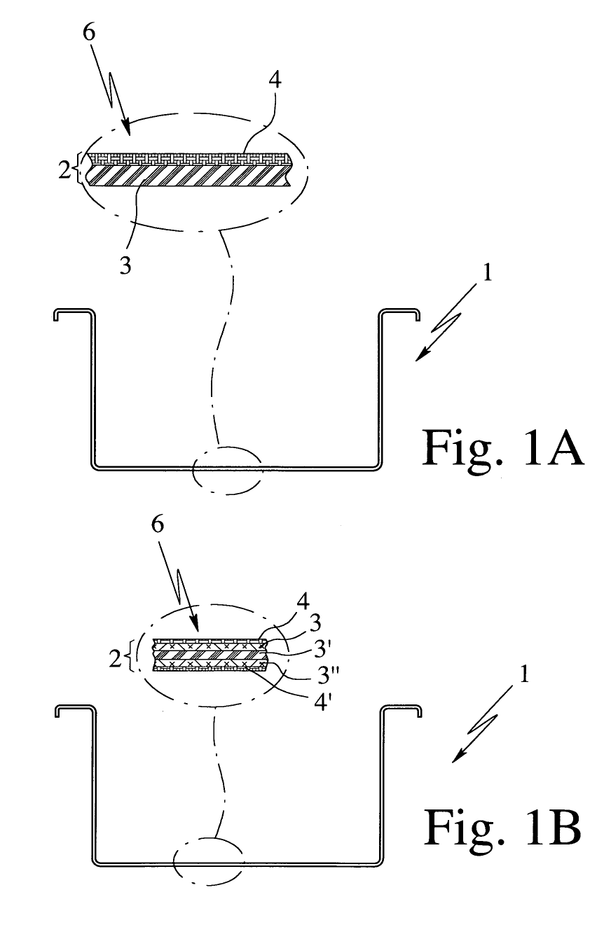

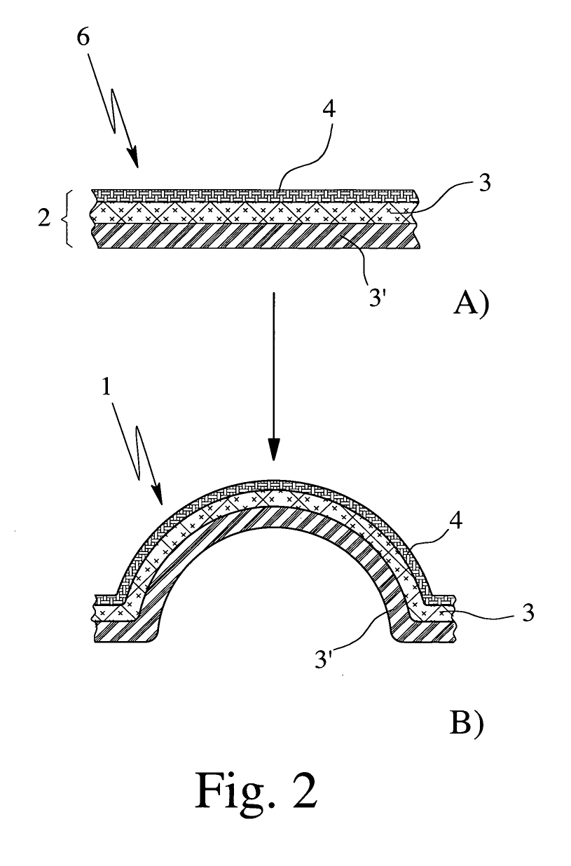

FIG. 1 shows a molded laminate 1 manufactured by means of the invented method that has a multilayer design 2 and a three-dimensional shape or structure. The molded laminate 1 manufactured with the aid of the invented method is particularly suitable for the manufacture of furniture, decorative elements, hollow channels, accessory and equipment parts for motor vehicles and the like. According to the schematic representation shown in FIG. 2, an at least substantially plate-shaped material piece 6 of multilayer design 2 is initially reshaped into the molded laminate 1 by means of the invented method, particularly thermoforming. According to FIG. 1A, the material piece 6 used for the invented method comprises at least one formable support 3, particularly a thermo-formable support 3, and at least one planar material 4, particularly a planar textile material, that is associated with the support 3.

The invented method is characterized in that the planar material 4 is laminated on the support 3 during the reshaping of the material piece 6, such that the support 3 and the planar material 4 can be displaced on or relative to one another during the reshaping process. After the reshaping process is completed, a molded laminate 1 is obtained in which the planar material 4 and the support 3 are immovably connected to one another.

According to the invention, it is therefore proposed that the layers, particularly the planar material 4 and the support 3, are laminated to one another during the reshaping process. Due to this measure, the respective layers, namely the planar material 4 and the support 3, are able to practically slide on one another during the reshaping process. This means that an “afterflow” or “continued sliding” of the planar material 4 takes place on the support 3 during the reshaping process such that the planar material 4 is freely movable relative to the support 3 on the surface thereof and the respective layers can slide on one another. It was surprisingly determined that particularly superior reshaping results can be achieved if the planar material 4 is substantially freely movable or freely displaceable on the support 3 during the shaping or reshaping process such that the respective layers can slide on one another. This measure prevents individual layers, particularly the planar material 4, from being subjected to excessive tensile and/or compressive stresses during the reshaping process, so that formation of creases, delamination and/or formation of cracks or tears is effectively prevented.

As described in greater detail below, the invented method is not limited to reshaping a 2-layer structure consisting of a planar material 4 and a support 3; on the contrary, materials with a layered structure consisting of three, four, five or more layers can also be reshaped with the invented method, wherein the respective layers are also laminated into a molded laminate 1 according to the invention during the reshaping process. Consequently, it is also ensured that the respective layers can be displaced on or relative to one another during the reshaping of a material piece with a multilayer design or multilayer structure 2.

After the completion of the reshaping process, which usually coincides with the cooling of the molded laminate 1, particularly to the ambient temperature such as room temperature, a stable layered composite with a rigid layered structure is obtained in which the individual layers, particularly the planar material 4 and the support 3, are immovably connected to one another such that the aforementioned layers can no longer be moved on or relative to one another after the molded laminate 1 cools. Since it usually suffices to cool a molded laminate 1 to room temperature in order to solidify the layered structure, no additional refrigerating or cooling devices are provided in the method according to the invention. However, such additional refrigerating or cooling devices can be provided, if so required, particularly for accelerating the cooling process.

According to the invention, the reshaping is carried out such that the material piece 6 is heated above the softening temperature of at least one layer, particularly the support 3, and the preferably thermoplastic material of the support 3 can be reshaped to a certain degree. The heating temperature during the reshaping process also must be chosen such that another layer can be laminated on during the reshaping process. For example, the temperature can be chosen such that at least one layer of the layered structure 2 or material piece 6 becomes adhesive at least on its surfaces under the influence of heat. If laminating means are used as proposed in another embodiment of the invention—which is described in greater detail below—the reshaping temperature should be chosen such that the corresponding laminating means become liquid or semiliquid or highly viscous and therefore develop a certain adhesiveness.

With respect to the method according to the invention, the planar material 4 is laminated on the support 3 at least substantially over its entire surface. In other words, the lamination is realized substantially over the complete or entire surface in the sense of the above-described definition, which can also include a discontinuous lamination.

According to one preferred embodiment of the invention, the planar material 4 and the support 3 can be prelaminated before the reshaping process such that a stable layered composite is already produced before the reshaping process. In this respect, the prelamination can be carried out in such a way that the planar material 4 is at least sectionally or completely connected to or laminated on the support 3, particularly as defined above. The prelamination ensures, for example, that the individual layers can no longer shift before the reshaping into the molded laminate 1. In other words, laminated material pieces 6 can already be utilized before the reshaping process in the method according to the invention, wherein the reshaping parameters, particularly the reshaping temperatures, must be chosen such that the already produced lamination is not separated or changed in such a way that the respective layers can shift during the reshaping process.

In the context of the invented method, it is possible for the pre-lamination between the planar material 4 and the support 3 to separate under the influence of heat, particularly during the reshaping process. In this case, the heating process should be carried out in such a way that the support 3 and the planar material 4 are displaced on and/or relative to one another during the reshaping process. This can but need not necessarily be realized, for example, by choosing the temperature during the reshaping process such that the laminating means used for the prelamination are correspondingly liquefied and transformed into a highly viscous or semiliquid state. A mutual displacement or sliding movement of the respective layers can be realized in this fashion. When utilizing an already prelaminated material piece 6, the existing lamination or bond is separated during the course of the invented method and produced again after the reshaping or the completion of the reshaping process, respectively.

With respect to the prelamination of the planar material 4 on the support 3, this can also be realized in the context of the present invention with the inherent adhesiveness of the support 3, particularly its adhesiveness under the influence of heat. According to this embodiment, at least the surface of the support 3 that is in contact with the planar material 4 is heated and transformed into an adhesive state during the reshaping process, with the heating process being carried out in such a way that the planar material 4 and the support 3 are displaced on or relative to one another during the reshaping process. In other words, the heating process is carried out such that existing laminations are at least partially separated and the respective layers can be displaced on or relative to one another. A cooling phase is initiated after the completion of the reshaping process so that the planar material 4 and the support 3 are immovably connected to one another after the reshaping process.

According to this embodiment, the lamination of the planar material 4 on the support 3 is realized during the reshaping process with the aid of the inherent adhesiveness of the support 3, particularly its adhesiveness under the influence of heat.

According to an alternative embodiment of the invention, the prelamination of the planar material 4 on the support 3 can—as described above—also be realized with the aid of laminating means, particularly an adhesive, in the context of the invented method. According to this embodiment, the laminating means are transformed into a liquid state, particularly a semiliquid or highly viscous state, during the reshaping process under the influence of heat, such that the planar material 4 and the support 3 can be displaced on and/or relative to one another while the reshaping process is carried out, i.e., already existing laminations are at least partially separated in order to enable the respective layers to be displaced during the reshaping process. After the reshaping is completed, a cooling phase is also initiated in this case such that a stable bond is produced and the layers are immovably connected to one another.

According to this embodiment, in which laminating means are used for the prelamination, the reshaping temperature is chosen such that the laminating means arranged or applied between the planar material 4 and the support 3 is changed in such a way that the existing lamination is at least partially separated and the respective layers can be displaced while the reshaping process is carried out.

After the completion of the reshaping or the reshaping process, the respective layers, particularly the planar material 4 and the support 3, are immovably connected to one another by means of cooling such that a rigid layered structure is produced. In other words, the cooling process is used for relaminating or initially laminating the aforementioned layers to one another during the reshaping process.

The invented method also includes an embodiment in which the planar material 4 is placed on the support 3 before the reshaping process without being connected thereto. In this context, the term “non-connected” should be understood to mean that the layers are not permanently connected to one another, for example, by simply placing the layers on one another and simultaneously or previously applying a hot-melt adhesive for laminating means. According to this embodiment, the optionally provided laminating means is not adhesive when the layers are placed on one another. Consequently, the term “not connected” also refers to embodiments in which the layers of the material piece 6 to be reshaped are held in contact with one another, if applicable, with the aid of a layer of laminating means that was applied beforehand and is not adhesive when the layers are placed on one another. The individual layers are not bonded to one another in this case.

According to this embodiment, the invented method can also be carried out such that the lamination of the planar material 4 on the support 3 is realized during the reshaping process, due to the inherent adhesiveness of the support 3, particularly its adhesiveness under the influence of heat. This is the case particularly if no laminating means were previously applied between the individual layers. Laminations to be produced, in particular, by utilizing the inherent adhesiveness of the support 3, particularly its adhesiveness under the influence of heat, can be realized by heating and thus transforming at least the surface of the support 3 is in contact with the planar material 4 into an adhesive state during the reshaping process such that the lamination is produced or created. After the reshaping process is completed, the laminate is subjected to a cooling process such that the lamination hardens and a rigid and immovable layered structure is obtained.

If a material piece 6 with non-connected layers is used in the method according to the invention, it is possible—as mentioned above—to additionally arrange or apply laminating means between the layers, particularly between the planar material 4 and the support 3, before the layers are placed on one another and the reshaping process is carried out. In this case, the laminating means is applied to the planar material 4 or on the support 3. The laminating means can be applied to either the surface of the support 3 and/or the surface of the planar material 4. If several or additional layers are provided in the context of the present invention, the laminating means can also be applied to both sides of the respective layers. The aforementioned laminating means can also be considered as suitable laminating means in this respect. It is also possible to place a hot-melt web between the respective layers. According to this embodiment in which the laminating means is provided between the non-connected layers, the lamination is produced during the reshaping process by means of previously applied laminating means, wherein the lamination is produced during the reshaping of the planar material 4 on the support 3 due to the transformation of the laminating means into a liquid state, particularly a semiliquid or highly viscous state, under the influence of heat. In other words, the reshaping temperature is chosen such that the laminating means is transformed into a liquid, particularly a semiliquid and/or highly viscous state, during the reshaping process. The reshaped laminate according to this embodiment is also cooled after the reshaping process such that the resulting molded laminate 1 has a layered structure, the layers of which are immovably connected to one another.

Consequently, a cooling process of molded laminate 1 also follows the reshaping in the embodiment wherein the layers of the material piece 6 are not connected before the reshaping process is carried out and wherein a laminating means, if applicable, is situated between the non-connected layers. Consequently, the planar material 4 and the support 3 are immovably connected to one another by means of a cooling process.

In the context of the invented method, the temperature during the reshaping process should generally be chosen such that it lies above the softening point of the preferably thermoplastic support 3 so as to achieve an optimal reshaping of the material piece 6 into the invented laminate 1.

With respect to the support 3, it is possible to use a support 3 of a foamed plastic, particularly one based on polyolefins or polyurethanes, especially polyolefins, wherein a closed-pore and/or closed-cell foamed plastic can be used for the support 3. According to the invention, a foamed plastic based on polyolefins is preferred. It is also possible, according to the invention, to utilize a polyethylene foam that can be peroxidically cross-linked. The foamed material can also be formable under the influence of heat, in the softening temperature being chosen such that the foamed plastic is not destroyed or excessively compressed during the reshaping of the material piece 6 into the molded laminate 1 according to the invention. The foamed plastic should at least have such properties that it can be reshaped as desired due to its elasticity in the method for manufacturing the invented laminate 1 and the utilization of the material piece 6. If another support 3′ is laminated on the side of the support 3 that lies opposite the planar material 4—as described below—and this additional support consists of a non-porous thermoplastic material, the support 3 and/or the planar material 4 are so to speak held in the resulting final shape by the support of 3′.

According to the invention, the support 3 preferably consists of a closed-pore or closed-cell foamed plastic that usually has a lower compressibility than open-pore materials and exhibits an optimal elastic and reversible compressibility under loads when it is used in the invented laminate 1. For example, the foamed material is compressed when a seat is subjected to a load (“sitting down”) such that the superior adaptability to the user results in a comfortable and pleasant sitting experience. In this case, the foamed material is able to reassume its original thickness after the load is alleviated (“getting up”).

If the support 3 is realized the form of a foamed plastic layer, it can have a thickness between 1 and 50 mm, particularly between 2 mm and 40 mm, preferably between 3 mm and 30 mm, preferably between 4 mm and 25 mm or, according to one particularly preferred embodiment 5 mm to 20 mm. In this case, the thickness can vary in broad ranges—depending on the intended use—and deviate from the cited values, if applicable. The apparent density of the support 3, particularly of the foamed plastic layer, can amount to 5-250 kg/m³, particularly 10-150 kg/m³, preferably 20-100 kg/m³, more preferably 25-95 kg/m³.

However, the support 3 could also consist of a thermoplastic material that is hard at its service temperature, particularly at room temperature (25° C.) and at atmospheric pressure. This means that the support 3 should be at least dimensionally stable and self-supporting at room temperature (25° C.) and at atmospheric pressure. The thermoplastic support 3 according to this embodiment should be realized, in particular, such that possibly existing restoring forces generated due to the presence of the planar textile material 4 and, if applicable, additional supports 3 and 3′ do not lead to a significant deformation of the molded laminate 1 after the reshaping process is carried out in order to manufacture the invented laminate 1.

According to this embodiment, the support 3 is preferably realized in a non-porous or non-foamed fashion. In other words, the support 3 according to this embodiment of the invention is solid and contains no cavities. This results in a particularly high dimensional or mechanical stability. In the context of the present invention, the material of the non-porous support 20 can be selected from polymers or copolymers. Polyolefins, vinyl polymers, polyamides, polyesters, polycarbonates or polyurethanes are preferably considered for this purpose. According to one preferred embodiment of the invention, the material of the support 3 contains polyolefins, especially polyethylene or polypropylene, particularly polypropylene copolymers or acrylonitrile/butadiene/styrene copolymers (ABS copolymers). With respect to additional details regarding the thermoplastic material, we refer to Römpp, Chemielexikon, 3. Edition, Volume 6, 1999, Georg Thieme Publishing House, Stuttgart/New York, pages 4505/4506, keyword: “Thermoplastics,” the entire disclosure of which, including that of bibliographic references cited therein, is hereby incorporated into the present application by reference.

The thickness of the support 3 can vary in broad ranges in the embodiment in which the support 3 is realized in the form of a non-porous support 3. According to the invention, the support 3 has a thickness of 1 mm to 20 mm, preferably 1.5 mm to 5 mm, particularly 2 mm to 10 mm, especially preferably 2.5 mm to 7 mm or, in one particularly preferred embodiment, 3 mm to 5 mm. However, it is possible to deviate from these values, depending on the respective application or individual instance, e.g., if the material piece 6 of the invented laminate 6 is used, for example, in the manufacture of furniture with a particularly high load bearing capacity. In this case, the thickness of the support 3 can exceed 15 mm.

With respect to the planar material 4 used in the method according to the invention, this planar material can consist of a planar textile material, particularly a woven fabric, an interlaced fabric, a knitted fabric or a nonwoven fabric, preferably a woven fabric. However, it is also possible for the planar material 4 to consist, for example, of leather or synthetic leather. It is furthermore possible for the planar material 4 to consist of film-like plastics and thin-walled metal foils. The planar material 4 can be selected, in particular, such that it is at least essentially light-tight.

The mass per unit area of the planar material 4 can vary in broad ranges. For example, the planar material 4 can have a mass per unit area of 25 to 600 g/m², preferably 50 to 500 g/m², more preferably 100 to 400 g/m².

According to one preferred embodiment of the invention, the planar material 4 is reversibly expandable and/or, in particular, bielastic, i.e., expandable in both directions, or highly elastic. The planar material 4 can have an extensibility of at least 5%, preferably at least 10%, particularly at least 20% in at least one direction, preferably in the longitudinal and lateral directions, in order to respond without tearing to the changes in length and width occurring during the reshaping process.

According to one particularly preferred embodiment of the invention, a particularly bielastic planar textile material 4 is used that has a warp elasticity of 35% or more and a weft elasticity of 20% or more. In order to manufacture a bielastic planar material of this type, it is possible, but by no means absolutely imperative to utilize special elastic yarns as described, for example, in EP 0 036 948 A1 of the same applicant, the entire disclosure of which is hereby incorporated into the present application by reference. This yarn is a particularly elastic yarn, in which an elastomer thread of approximately 140 to 200 denier is adhesively twisted with two yarns, the thickness of which respectively amounts to approximately one-tenth of the thickness of the elastomer yarn. In this case, the yarns preferably consist of OE yarns (“Open-End yarns”) that are manufactured by the rotor method and consist of polyvinyl chloride threads, polyvinyl cyanide threads, polyacrylonitrile threads and/or wool threads. According to the invention, it would also be possible to utilize the bielastic planar material that is described in DE 29 57 498 C2 of the same applicant, the disclosure of which is hereby also incorporated in its entirety into the present application by reference.

According to one particularly preferred embodiment, a bielastic planar material is used that has a weight of 350 g/m², a warp elasticity of at least 35% and a weft elasticity of at least 20%. Such a planar material can comprise, for example, approximately 4.8% Elastan®, approximately 89.3% polyester and approximately 5.9% polyamide. According to the invention, it is also possible for the planar material 4 to be additionally impregnated, coated or the like in order to render the planar material 4 flame-retarding or dirt-repelling.

As described above, the present invention is not limited to a 2-layer structure of the invented laminate 1. According to FIG. 2A, it is possible, according to the invention, to provide another support 3′, this additional support preferably being arranged on the side of the support 3 that faces away from the planar material 4. With respect to the realization of the supports 3 and 3′, it is possible to design these supports identically or differently. According to one particularly preferred embodiment of the invention, the support 3, on which the planar material 4 is arranged, is realized in the form of a foamed plastic, particularly as defined above. The support 3′ is laminated on the side of the support 3 facing away from the planar material 4 and consists of a non-porous and/or non-foamed thermoplastic support, particularly as defined above. The support 3 is realized in the form of an intermediate layer 5 of sorts in this embodiment.

According to the invention, it is furthermore possible to arrange or laminate another support 3″ that is realized identically to or differently from the latter-described support and/or another planar material 4′ on the side of the support 3′ that faces away from the support 3, particularly as defined above. In this case, the support 3 also acts as an intermediate layer 5 of sorts that preferably consists of foamed plastic. This foamed plastic then forms the core of the laminate structure.

According to another embodiment of the invention, the molded laminate 1 can comprise a support 3, the support 3 consisting of a foamed plastic as described above. According to this embodiment, an above-defined planar material 4, in particular, can be laminated on the support 3. In this embodiment, another support 3′ is laminated on the side of the support 3 that faces away from the planar material 4, wherein this support preferably consists of a non-porous support on the basis of a thermoplastic material, particularly as defined above.

With respect to the embodiment of the invention that comprises more than two layers, the previous explanations of the invented method regarding the 2-layer structure apply analogously in this case. In other words, the respective layers of a layered structure comprising more than two layers are, in principle, moved during the reshaping process such that the individual layers are displaced on and/or relative to one another in the above-described fashion. The individual layers of a multilayer variation can also be prelaminated as mentioned above with respect to the 2-layer embodiment, for example, with the aid of the adhesiveness under the influence of heat and/or the utilization of a laminating means. However, it would also be possible to subject a multilayer material piece 6 to the invented method for realizing a multilayer molded laminate 1 with rigid layered structure, in which the respective layers are not connected in the above-described sense.

With respect to additional details regarding the planar material 4 and the support 3, which can also be realized in the form of an intermediate layer 5 in an alternative embodiment of the invention, as well as with respect to the optionally provided support 3′, we refer to U.S. patent application Ser. Nos. 11/430,802 (“Multilayered Material Part and Formed Part Produced Therefrom”), filed May 9, 2006, and Ser. No. 11/430,318 (the “Structural Unit in the Form of a Cavity-Formed Part and Use Thereof”), filed May 9, 2006, of the applicant, the entire disclosures of which are hereby incorporated into the present application by reference.

With respect to the invented method, it is possible to mount or fix the material piece 6 in a holding frame well known to those in the art, particularly on the edge regions of the material piece 6. This holding frame essentially serves for fixing the material piece 6 and/or for generating an initial stress before the material piece 6 is pressed into the mold by means of the above-described die and drawn. The holding frame therefore is realized similar to a tenter or mounting frame. According to this embodiment of the invention, in which a holding frame is used for reshaping the material piece 6 into a molded laminate 1, the material piece 6 is preferably inserted into the holding frame such that the planar material 4 is displaced during the reshaping process. In other words, the holding frame is adjusted such that the planar material 4 is not completely fixed or clamped in position by the holding frame and the planar material 4 is practically able to slide or flow in the edge region of the material part 6 fixed by the holding frame. This additionally improves the overall mobility of the planar material 4 relative to the support 3 during the reshaping process such that particularly good results with respect to the invented laminate 1 are achieved.

With respect to the dimensions of the planar material 4 and the support 3 and/or the support 3′, the invention proposes that the aforementioned layers have identical dimensions relative to the surface, i.e., the layers are practically arranged on the material piece 6 congruently. It is possible for the edge regions of the layers 4, 3, 3′ not to laminate in this case, so that these edge regions of the planar material 4 and the support 3 can practically be lifted off the optionally provided support 3′. The non-lamination of the edge regions is not limited to the aforementioned layers. Thus, the optionally provided layers 3″ and/or 4′ can also be non-laminated.

According to another embodiment, the planar material 4 is realized with smaller dimensions relative to the surface of the support 3 and/or the optionally provided support 3′, wherein the support 3 and/or 3′ extend(s), relative to the surface, over at least one edge of the planar material 4 such that the planar material 4 is not accommodated and fixed by the holding frame. Due to the fact that the planar material 4 is not accommodated and fixed in position by a holding frame, the invention makes it possible to realize a particularly good “afterflow” or “continued sliding” of the planar material 4 during the reshaping of the material piece 6 into the invented laminate 1.

According to the invention, it is furthermore possible to simultaneously reshape a first material piece 6a into a first molded laminate 1a and a second material piece 6b into a second molded laminate 1b, wherein the first molded laminate 1a and the second molded laminate 1b are connected to one another in such a way that the molded laminates 1a, 1b form one structural unit 7 with at least one cavity. According to this special embodiment of the above-described invented method, the reshaping for the manufacture of the structural unit 7 can be realized by means of thermoforming, particularly the so-called twin-sheet thermoforming method. For more detailed information on the twin-sheet thermoforming method, we refer to DE 10 2005 054 063 of Nov. 10, 2005 that was submitted by the same applicant and the entire disclosure of which is hereby incorporated into the present application by reference. In the so-called twin-sheet method, the planar material 4 is laminated on the support 3 during the reshaping of the material piece 6, such that the support 3 and the planar material 4 form one structural unit and practically represent molded laminates 1a, 1b that are combined into a structural unit 7 during the reshaping process. In this case, the planar material 4 and the support 3 are respectively connected to one another in an immovable fashion.

The invention also pertains—according to another aspect thereof—to a molded laminate 1, particularly for the manufacture of furniture, decorative elements, hollow channels, fixtures, e.g., for automobiles and the like, that can be manufactured in accordance with the invented method. The molded laminate 1 according to the invention has the advantage that its product properties are significantly improved in comparison with the state of the art due to the specific manufacture. For example, the invented laminate 1 has a significantly lower tendency to form creases or bubbles and a substantially diminished delamination effect. Due to the ability to displace the respective layers during the reshaping process, the molded laminate 1 according to the invention has somewhat lower restoring forces because the individual layers are applied or laminated with low tension since they are able to “flow after” or “continue sliding” during the manufacturing process. Consequently, the invented laminate 1 has a significantly improved delamination resistance as well as a substantially improved dimensional stability.

The molded laminate according to the invention can be used, in particular, for the manufacture of furniture, particularly seats and furnishings for interior as well as exterior use. The invented laminate is particularly suitable for manufacturing seats, wherein the term “seat” should be interpreted in a broad sense; for example, the term “seats” includes seating accommodations and seating elements of all types that include but are not restricted to benches, loungers, chairs, sofas, sectionals, stools and the like. In this case, the seat can be designed such that it consists of a molded laminate according to the invention or comprises at least one such molded laminate.

The invented laminate can also be used for saddles such as bicycle saddles and the like, in particular, because the molded laminate according to the invention can feature, for example, significant curvatures or molded regions. Consequently, a saddle manufactured from the invented laminate can be easily adapted to the anatomy of the respective user. Another application of the invented laminate is the utilization for seats in public transportation means because the specific layered structure described above with the flat lamination results in superior dirt repelling properties. In addition, the invented laminate can be used as a decorative element, for example, in the form of a cable covering, a partition wall, a cover and the like. The invented laminate can also be used, in principle, in the automobile industry, e.g., in the form of linings for cars doors and the like.

The method according to the invention for manufacturing a molded laminate as well as the molded laminate as such and furnishings manufactured thereof, e.g., furniture such as seats, have numerous advantages, of which the following are cited in a purely exemplary fashion:

Due to the special manufacturing sequence according to the invention that makes it possible, in particular, for the planar material to “flow after” or “continue sliding” during the reshaping process, individual layers are not subjected to excessive tensile and compressive stresses during the reshaping process. The formation of creases, delamination or the formation of cracks and/or tearing of individual layers are effectively prevented in this fashion.

The invented method significantly lowers the reject rate in the manufacture of molded laminates according to the invention, because the formation of creases and bubbles, delamination and the formation of cracks are prevented during the reshaping process.

The manufacture of the molded laminate according to the invention comprises only a small number of manufacturing steps with minimal tooling costs such that this is an exceptionally cost-efficient method.

Complete units furniture, for example, a chair/backrest of a seat, can be manufactured in the desired final shape with only a small number of manufacturing steps with the method according to the invention.

Due to the optionally provided solid thermoplastic support, the molded laminate according to the invention has a self-supporting function after the reshaping process; this is particularly important with respect to seating systems.

The invented method makes it possible to realize numerous different shapes and structures, so that the molded laminate according to the invention can be used in a wide range of applications.

The individual design of the respective layers makes it possible to significantly vary and customize the corresponding product properties—while simultaneously providing very attractive and individual surface design options (fabric cover).

Due to the inventive principle, according to which, in particular, the planar textile material is laminated onto the supporting layer during be reshaping process, it is possible to obtain a practically finished product after the reshaping process, so that the subsequent “application” of additional layers that frequently leads to delamination and the formation of creases is entirely eliminated.

Due to the special laminated design with a preferably massive thermoplastic support, the invented laminates have a high stability, so that they can be used for numerous applications, for example, within seats or in the form of seats.

Upon reading through this description, a person skilled in the art should be able to identify and realize other embodiments, modifications or variations of the present invention easily without deviating from the scope thereof.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A method for manufacturing a molded laminate of multilayer design and three-dimensional shape, comprising the following steps:
providing a plate-shaped material piece of multilayer design, wherein the material piece comprises at least one formable support and at least one planar material associated with the support;
reshaping said material piece into a molded laminate; and
laminating the planar material onto the support during the reshaping of the material piece, wherein the support and the planar material are displaced on and/or relative to one another during the reshaping process and a molded laminate, in which the textile material and the support are immovably connected to one another, is obtained after the completion of the reshaping process.

2. The method according to claim 1, wherein the support consists of a thermoformable support and the reshaping process is realized by means of thermoforming, and wherein the planar material consists of a textile fabric.

3. The method according to claim 1, wherein the planar material is laminated on the entire surface of the support.

4. The method according to claim 1, wherein the planar material and the support are prelaminated before the reshaping process, wherein the prelaminating of the planar material on the support is loosened under the influence of heat during the reshaping in such a way that the support and the planar material are displaced on and/or relative to one another during the reshaping process.

5. The method according to claim 4, wherein the prelaminating of the planar material on the support is achieved due to the inherent adhesiveness of the support or its adhesiveness under the influence of heat, wherein at least the surface of the support that is in contact with the planar material is transformed into an adhesive state by means of a heating during the reshaping process, in such a way that the planar material and the support are displaced on and/or relative to one another during the reshaping, and wherein the thus-formed laminate is cooled after the completion of the reshaping process so that the planar material and the support are immovably connected to one another.

6. The method according to claim 4, wherein the prelamination of the planar material on the support is achieved with the aid of a laminating means, wherein the laminating means is transformed into a liquid or adhesive state by means of heating during the reshaping process, in such a way that the planar material and the support are displaced on and/or relative to one another during the reshaping, and wherein the thus-formed laminate is cooled after the completion of the reshaping process such that the planar material and the support are immovably connected to one another.

7. The method according to claim 1, wherein the planar material is placed on the support without being connected thereto before the reshaping process, wherein the lamination of the planar material on the support is achieved due to the inherent adhesiveness of the support or its adhesiveness under the influence of heat during the reshaping, wherein at least the surface of the support that is in contact with the planar material is transformed into an adhesive state by means of heating during the reshaping process, and wherein the thus-formed laminate is cooled after the completion of the reshaping process such that the planar material and the support are immovably connected to one another.

8. The method according to claim 1, wherein the lamination is achieved with the aid of laminating means that is applied before the reshaping process, wherein the lamination of the planar material on the support is achieved due to the transformation of the laminating means into a liquid or adhesive state by means of heating during the reshaping, and wherein the thus-formed laminate is cooled after the completion of the reshaping process such that the planar material and the support are immovably connected to one another.

9. The method according to claim 1, wherein said reshaping process is realized by thermoforming.

10. The method according to claim 1, wherein a foamed plastic or a thermoplastic material is used for the support, and wherein the planar material consists of a textile fabric that is selected from the group comprising woven fabrics, interlaced fabrics, knitted fabrics, formed fabrics or nonwovens.

11. The method according to claim 1, wherein at least one additional support is arranged on the side of the support that faces away from the textile material.

12. The method according to claim 1, wherein the material piece is fixed in a holding frame in the edge regions of the material piece during the reshaping process.

13. The method according to claim 12, wherein the material piece is inserted into the holding frame in such a way that the planar material can be displaced during the reshaping process.

14. The method according to claim 12, wherein the dimensions of the planar material relative to the surface are smaller than those of the support and, optionally, the additional support, and wherein the support and, optionally, the additional support extend over at least one edge of the planar material relative to the surface, in such a way that the planar material is not fixed by the holding frame.

15. The method according to claim 1, wherein a first material piece is reshaped into a first molded laminate and a second material piece is simultaneously reshaped into a second molded laminate, and wherein the first molded laminate and the second molded laminate are connected to one another in such a way that the two resulting molded laminates form a structural unit with at least one cavity.

16. The method according to claim 15, wherein the reshaping process for manufacturing the structural unit is realized by means of thermoforming.

17. The method according to claim 15, wherein the reshaping process for manufacturing the structural unit is realized by means twin-sheet thermoforming.

18. A molded laminate manufactured with a method according to claim 1.

19. The molded laminate according to claim 18, wherein the molded laminate comprises a support, a planar material laminated onto the support and, if applicable, another support that is laminated onto the side of the support facing away from the planar material, wherein all layers are laminated to one another over their entire surface, and wherein the molded laminate features three-dimensional nonplanar regions.

20. The molded laminate according to claim 19, wherein the three-dimensional nonplanar regions are realized in the form of bulges, indentations, depressions or bends.

21. The molded laminate according to claim 18, wherein the molded laminate forms part of furniture, decorative elements, hollow channels or automobile accessories.
